(19) United States
(12) Patent Application Publication
(10) Pub. No.: US 2024/0303539 A1
(43) Pub. Date: Sep. 12, 2024

(54) METHODS AND APPARATUSES FOR GENERATING ONE OR MORE ANSWERS RELATING TO FUNCTIONING OF A MACHINE LEARNING MODEL

(71) Applicant: TELEFONAKTIEBOLAGET LM ERICSSON (PUBL), Stockholm (SE)

(72) Inventors: Ajay KATTEPUR, BANGALORE (IN); Swarup KUMAR MOHALIK, Bangalore Karnataka (IN); Perepu SATHEESH KUMAR, Chennai (IN)

(73) Assignee: TELEFONAKTIEBOLAGET LM ERICSSON (PUBL), Stockholm (SE)

(21) Appl. No.: 18/276,380

(22) PCT Filed: Feb. 19, 2021
(86) PCT No.: PCT/IN2021/050158

§ 371 Date: Aug. 8, 2023

(51) Int. Cl. G06N 20/00

(52) U.S. Cl. CPC G06N 20/00

(57) ABSTRACT

Embodiments described herein relate to methods and apparatuses for generating one or more answers relating to a machine learning, ML, model. A method in a first node comprises obtaining one or more queries relating to a first output of the ML model, wherein the first output of the machine learning, ML, model is intended to fulfil one or more requirements in an environment; for each of the one or more queries performing a reinforcement learning process. The reinforcement learning process comprises: generating a first set of answers to the query based on the one or more requirements; obtaining a first set of rewards associated with the query, wherein each reward in the first set of rewards is associated with a respective answer in the first set of answers, wherein each reward in the first set of rewards is determined based on one or more metrics; and iteratively generating updated sets of answers associated with the query based on a set of rewards associated with a set of answers from a preceding iteration until a terminal set of answers is reached, in which a second set of answers is generated based on the first set of rewards. Responsive to at least one reward from the reinforcement learning process associated with each query meeting a first predetermined criterion, the method then further comprises initiating implementation of the first output of the ML model in the environment.

### TECHNICAL FIELD

Embodiments described herein relate to methods and apparatuses for generating answers for queries relating to the functioning of a machine learning model.

### BACKGROUND

Structured domains such as telecommunication inspection, factory operations and network management are increasingly making use of autonomous agents for monitoring, diagnosis and actuation. These autonomous agents typically make use of Artificial Intelligence (AI) planning and learning techniques to understand domain specifications and problem goals. Explainers may also be deployed that can explain the reasons for a particular planned action in a plan developed by a planner.

Before deploying planners and any corresponding explainers in a structured domain, it is may be important for the explainable decisions provided by the planner, or the explanations provided by the explainer, to first satisfy an audit. For example, an audit may determine the accuracy of the explanations provided by the explainer. As there may be multiple combinations of generated plans, queries provided to the explainer, and explanations provided by the explainer in response to the received queries, an auditing process may require a structured technique in order to provide objective feedback to the planners (also known as planning agents) and explainers (also known as explaining agents) to in order to improve the plans and explanations respectively.

It may be desirable for explainers to provide explanations in a format that may be easily compared with other explanations (for example, comparison with explanations that are likely to be accepted as part of an auditing process pre deployment). It may also be desirable to provide a mechanism by which explanations provided by an explainer can be improved in an auditing process.

### SUMMARY

According to some embodiments there is provided a method in a first node for generating one or more answers relating to a machine learning, ML, model. The method comprises: obtaining one or more queries relating to a first output of the ML model, wherein the first output of the machine learning, ML, model is intended to fulfil one or more requirements in an environment. For each of the one or more queries the method comprises performing a reinforcement learning process comprising: generating a first set of answers to the query based on the one or more requirements; obtaining a first set of rewards associated with the query, wherein each reward in the first set of rewards is associated with a respective answer in the first set of answers, wherein each reward in the first set of rewards is determined based on one or more metrics; and iteratively generating updated sets of answers associated with the query based on a set of rewards associated with a set of answers from a preceding iteration until a terminal set of answers is reached, in which a second set of answers is generated based on the first set of rewards. The method then further comprises responsive to at least one reward from the reinforcement learning process associated with each query meeting a first predetermined criterion, initiating implementation of the first output of the ML model in the environment.

An objective technical problem to be solved by the method above is how to improve the ability to provide satisfactory explanations, and to thereby improve the likelihood of an output being deployed.

In some embodiments, the step of iteratively generating updated sets of answers comprises: generating an updated set of answers to the query based on a set of rewards from a preceding iteration and the one or more requirements; and obtaining an updated set of rewards associated with the query, wherein each reward in the updated set of rewards is associated with a respective answer from the updated set of answers.

In some embodiments, the method further comprises performing the step of generating an updated set of answers responsive to a determination that one or more updated answers can be provided that could be associated with a reward that is greater than any of the rewards generated in any previous iteration. In some embodiments the method further comprises responsive to a determination that one or more answers cannot be provided that could be associated with a reward that is greater than any of the rewards generated in any previous iteration, setting a last generated updated set of answers as the terminal set of answers. This allows the iterations to continue until a best possible terminal set of answers is reached.

In some embodiments the method further comprises responsive to at least one reward from the reinforcement learning process associated with each query meeting a first predetermined criterion, setting a last generated set of answers as the terminal set of answers. This allows the iterations to stop as soon as a set of answers is reached that will pass the audit.

In some embodiments, the step of generating a first set of answers to the query based on the one or more requirements comprises generating a first set of answers using a Markov Decision Process.

In some embodiments each answer within the first set of answers is based on a respective templated format. For example, each respective templated format may comprise an Easy Approach to Requirements Syntax template. The use of a templated format allows for a specification language that is common to both an explainer and a critic.

Each answer within the first set of answers may comprise at least one of the one or more requirements. At least one answer within each iteration of the updated set of answers may comprise a composite answer formed of at least two of the one or more requirements. In some embodiments the step of iteratively generating updated sets of answers associated with the query until a terminal set of answers is reached comprises: iteratively generating updated sets of composite answers associated with the query. In other words, the answers may be produced from the one or more requirements by iteratively producing composite answers that may receive higher rewards.

In some embodiments the method comprises, for each of the one or more queries, storing a terminal answer template based on the structure of the terminal set of answers to the query. For each of the one or more queries, the method may comprise storing the terminal answer template associated with a query template for the query and/or an indication of a type of a part of the first output that the query referred to. The method may then further comprise: responsive to receiving one or more queries relating to a second output of the ML model, generating one or more answers to one or more additional queries relating to the second output of the ML model, wherein the one or more answers are generated based on the terminal answer template. The terminal answer template may therefore be used in an online manner to produce answers to queries that are more likely to pass an audit.

In some embodiments, the one or more queries are generated based on one or more respective query templates associated with a type of the first output of the ML model. This allows appropriate queries to be generated based on the type of output of the ML model.

The one or more metrics may comprise one or metrics determined based on one or more of: a comprehensibility of each answer, a succinctness of each answer, an actionability of each answer, a reusability of each answer, an accuracy of each answer and a completeness of each answer.

In some embodiments, the ML model is configured to determine at least one plan for a drone to inspect one or more defects in a telecommunication system.

According to some embodiments there is provided a method in a second node, for obtaining one or more answers relating to a machine learning model. The method comprises: obtaining one or more queries relating to a first output of the ML model, wherein the first output of the machine learning, ML, model is intended to fulfil one or more requirements in an environment; for each of the one or more queries performing a reinforcement learning process comprising: obtaining a first set of answers to the query based on the one or more requirements; generating a first set of rewards associated with the query based on one or more metrics, wherein each reward in the first set of rewards is associated with a respective answer in the first set of answers; obtaining iteratively generated updated sets of answers associated with the query based on a set of rewards associated with a set of answers from a preceding iteration until a terminal set of answers is reached, in which a second set of answers is generated based on the first set of rewards; and responsive to at least one reward from the reinforcement learning process associated with each query meeting a first predetermined criterion, initiating implementation of the first output of the ML model in the environment.

An objective technical problem to be solved by the method above is how to improve the ability to provide satisfactory explanations, and to thereby improve the likelihood of an output being deployed.

In some embodiments, the method comprises generating the one or more queries based on one or more respective query templates associated with a type of the first output of the ML model. This allows appropriate queries to be generated based on the type of output of the ML model.

Each answer within the first set of answers is based on a respective templated format. For example, each respective templated format may comprise an Easy Approach to Requirements Syntax template.

The one or more metrics may comprise one or metrics determined based on one or more of: a comprehensibility of each answer, a succinctness of each answer, an actionability of each answer, a reusability of each answer, an accuracy of each answer and a completeness of each answer.

In some embodiments, the ML model is configured to determine at least one plan for a drone to inspect one or more defects in a telecommunication system.

According to some embodiments there is provided a first node for generating one or more answers relating to a machine learning, ML, model. The first node comprises processing circuitry configured to cause the first node to: obtain one or more queries relating to a first output of the ML model, wherein the first output of the machine learning, ML, model is intended to fulfil one or more requirements in an environment; for each of the one or more queries perform a reinforcement 30 learning process comprising: generating a first set of answers to the query based on the one or more requirements; obtaining a first set of rewards associated with the query, wherein each reward in the first set of rewards is associated with a respective answer in the first set of answers, wherein each reward in the first set of rewards is determined based on one or more metrics; and iteratively generating 35 updated sets of answers associated with the query based on a set of rewards associated with a set of answers from a preceding iteration until a terminal set of answers is reached, in which a second set of answers is generated based on the first set of rewards; and responsive to at least one reward from the reinforcement learning process associated with each query meeting a first predetermined criterion, initiate implementation of the first output of the ML model in the environment. The processing circuitry may be further configured to cause the first node to perform the method as described above with reference to a first node.

According to some embodiments there is provided a second node for obtaining one or more answers relating to a machine learning model. The second node comprises processing circuitry configured to cause the second node to: obtain one or more queries relating to a first output of the ML model, wherein the first output of the machine learning, ML, model is intended to fulfil one or more requirements in an environment; for each of the one or more queries perform a reinforcement learning process comprising: obtaining a first set of answers to the query based on the one or more requirements; generating a first set of rewards associated with the query based on one or more metrics, wherein each reward in the first set of rewards is associated with a respective answer in the first set of answers; obtaining iteratively generated updated sets of answers associated with the query based on a set of rewards associated with a set of answers from a preceding iteration until a terminal set of answers is reached, in which a second set of answers is generated based on the first set of rewards; and responsive to at least one reward from the reinforcement learning process associated with each query meeting a first predetermined criterion, initiate implementation of the first output of the ML model in the environment. The processing circuitry may be further configured to cause the second node to perform the method as described above with reference to a second node.

According to some embodiments there is provided a computer program product comprising a computer readable medium, the computer readable medium having computer readable code embodied therein, the computer readable code being configured such that, on execution by a suitable computer or processor, the computer or processor is caused to perform a method as described above.

The embodiments described herein thereby provide for an actor-critic auditing system to check for explainability of AI plans using reinforcement learning.

Accurate explanations of planned outputs are provided in a templated format, for example, using EARS syntax rules. Critic rewarded answers may be composed in an optimal fashion to ensure answers are neither too generic nor too verbose. The resulting combination of <plans, answers> have improved on-field performance due to offline explanation audits. Autonomous agents may be deployed, for example, in telecom maintenance, and may be audited to maintain a degree of explanation performance.

Because of the structured environments in which the ML models are operating, the space of outputs, queries and answers may be well-defined using templated formats. Once converged, the embodiments described herein may be deployed for any planning system and will output answers for any query that are more likely to pass auditing.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an example of an auditing system in accordance with the present disclosure;

FIG. 2 illustrates a method in a first node for generating one or more answers relating to a machine learning, ML, model;

FIG. 3 illustrates a method in a second node, for obtaining one or more answers relating to a machine learning model;

FIG. 4 illustrates an example of the iterative process of step 204 of FIG. 2 for a query in more detail;

FIG. 5 illustrates an example in which the ML model is configured to determine at least one plan for a drone to inspect one or more defects in a telecommunication system;

FIG. 6 is a radar diagram that illustrates a technique to objectively measure the efficacy of the answers;

FIG. 7 is a signalling diagram illustrating an example implementation of the methods of FIGS. 2 and 3;

FIG. 8 illustrates a first node comprising processing circuitry (or logic);

FIG. 9 illustrates a second node comprising processing circuitry (or logic).

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

When herein referring to a process and a model, what is referred to is generally a machine learning process and a machine learning model.

A process, in the context of machine learning, may be defined as a procedure that is run on data to create a machine learning model. The machine learning process comprises processes and/or instructions through which data, generally referred to as training data, may be processed or used in a training process to generate a machine learning model. The process learns from the training data, also referred to as that the process is fitted to a dataset comprising training data. Machine learning processes can be described using math, such as linear algebra, and/or pseudocode, and the efficiency of a machine learning process can be analyzed and quantized. There are many machine learning processes, such as e.g. processes for classification, such as k-nearest neighbors, processes for regression, such as linear regression or logistic regression, and processes for clustering, such as k-means. Further examples of machine learning processes are Decision Tree processes, Artificial Neural Network processes and Reinforcement Learning, RL, processes. Machine learning processes can be implemented with any one of a range of programming languages.

The model, or machine learning model, may comprise both data and procedures for how to use the data to e.g. make a prediction, perform a specific task or for representing a real-world process or system. The model represents what was learned by a machine learning process when trained by using training data and is what is generated when running a machine learning process. The model represents e.g. rules, numbers, and any other process-specific data structures or architecture required to e.g. make predictions. The model may e.g. comprise a vector of coefficients (data) with specific values (output from a linear regression algorithm), a tree of if/then statements (rules) with specific values (output of a decision tree algorithm) or a graph structure with vectors or matrices of weights with specific values (output of an artificial neural network applying backpropagation and gradient descent).

Embodiments described herein relate to methods and apparatuses for an automated auditing process that audits explanations of outputs provided by a machine learning, ML, model. In particular, reinforcement learning processes are used to audit the explanations that are provided by explaining agents.

Structuring one or more requirements that the ML model uses to determine its output provides a search space that can be used to determine explanations. In other words, the one or more requirements may themselves, either individually or in combination, explain why a particular action has been output.

Trade-offs between explanations and their evaluations may also be incorporated in order to compose a suitable granularity of explanation.

Examples described herein refer to the ML model comprising an AI planning model. However, it will be appreciated that the methods described herein may be equally applied to any other type of ML model for example, reinforcement learning or Bayesian graphs. An ML model may provide an ML output for implementation in a particular environment. For example, the environment may comprise telecommunication inspection, factory operations or network management.

Aspects of the present disclosure thus provide methods that allows for improved combinations of ML outputs and their corresponding explanations. Those outputs that have explanations that pass auditing may be allowed to be deployed in the environment. Therefore, by improving the ability to provide satisfactory explanations, the likelihood of an output being deployed is improved.

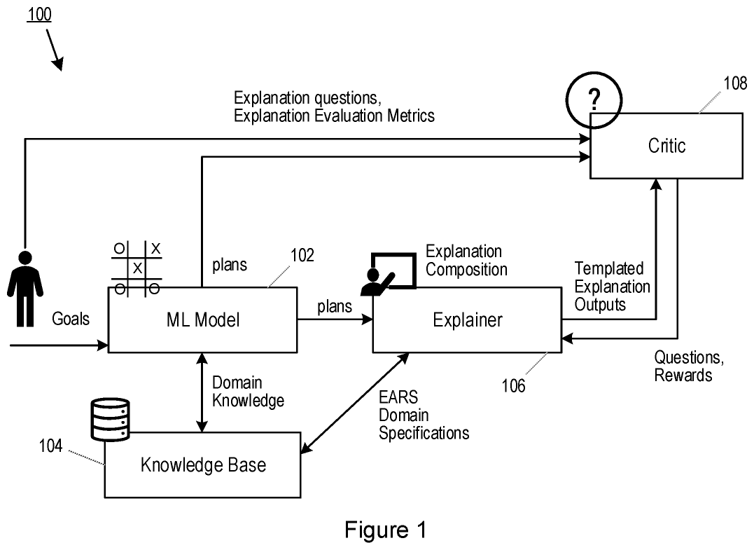

FIG. 1 illustrates an example of an auditing system 100 in accordance with the present disclosure. It will be appreciated that this auditing system may be applied in a structured environment, for example, for telecommunication inspection, factory operations or network management. It will be appreciated that in a structured environment such as the examples given above, the possible actions within that structured environment, and semantic knowledge relating to that structured environment may be known by the auditing system 100. It will also be appreciated that the auditing system 100 may be implemented in a cloud environment.

The auditing system 100 comprises an ML model 102, a knowledge base 104, an explainer 106 and a critic 108. It will be appreciated that in some examples, the explainer 106 and the critic 108 may be co-located. For example, in cloud-based deployments of the present embodiments, the explainer 106 and critic 108 may be located on the same server. For example, the explainer 106 and the critic 108 may both be located within network edge or cloud servers associated with the environment. The knowledge base may also be deployed on a network edge or cloud server.

The ML model 102 generates an output. For example, where the ML model comprises an AI planner, the output may comprise a number of plans generated utilising information i.e. domain knowledge obtained from the knowledge base 104. For example, the information obtained from the knowledge base 104 may comprise heuristics and/or relaxation goals. It will be appreciated that a number of plans may be generated by ML model 102 on varying problem instances, goals, heuristics and relaxation constraints. The ML model 102 may generate the output in an offline manner.

It will be appreciated that the ML model 102 may alternatively comprise a neural network, or a reinforcement learning based ML model, or any other suitable ML model.

The number of generated plans are then transmitted to the explainer 106, and to the critic 108.

The critic 108 poses a number of queries based on the obtained output i.e. the generated plans.

For example, where the output comprises one or more plans generated by an AI planner, the queries may be based on multiple paths comprised within the obtained plans.

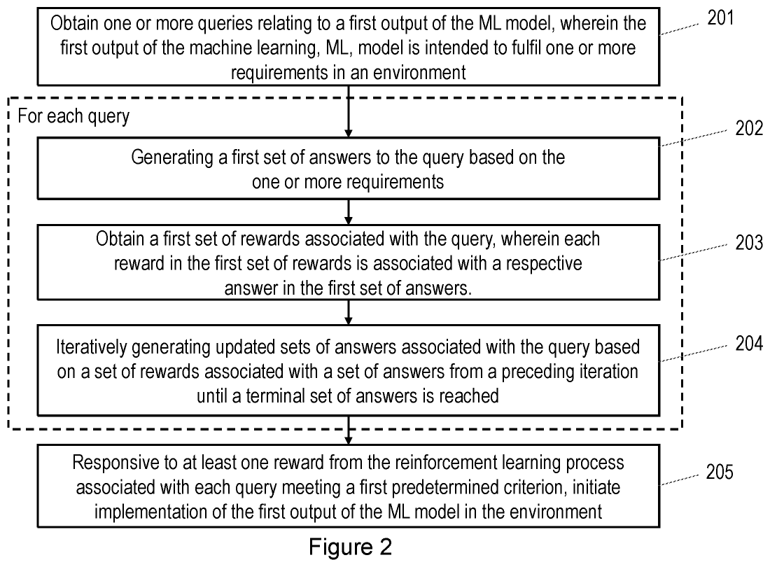

It will be appreciated that the queries posed by the critic 108 may be based on historical data relating to outputs generated by the ML model 102, and/or be based on the result of previous audits performed by the critic 108. It will also be appreciated that the queries posed by the critic may conform to a specific query template, as will be described in more detail later with reference to FIG. 2.

One or more metrics may then be used to evaluate one or more answers to the queries received from the explainer 106. Each answer provided by the explainer 106 may then be given a reward by the critic 108 based on the one or more metrics. These rewards may be provided to the explainer 106, and the explainer 106 may then provide updated answers to the critic 108.

The explainer 106 may therefore continually learn by choosing appropriate templated requirements to generate updated answers. The templates used for the requirements may be generated based on EARS specification, as will be described in more detail with reference to FIG. 2.

The process may terminate when at least one answers to each query posed by the critic 108 reaches a minimum expected reward or reaches a Pareto Optimal value that is the best possible explanation for the query. In these cases, the audit may be considered passed.

The RL process running in the explainer 106 and the critic 108 may therefore explore all possible explanations based on the requirements of the ML model 102 until a reward threshold (based on the metrics) is reached. The explainer 106 may then populate the audited deployment system with well rewarded tuples of output queries and answers that are to be used within live deployments. As the outputs have safely passed offline audits, the possibility of explanations that may be rejected online is thus reduced.

FIG. 2 illustrates a method in a first node for generating one or more answers relating to a machine learning, ML, model. For example, the method of FIG. 2 may be performed by the explainer 106 of FIG. 1. The ML model may comprise the ML model 102 of FIG. 1.

In step 201, the first node obtains one or more queries relating to a first output of the ML model, wherein the first output of the, ML, model is intended to fulfil one or more requirements in an environment.

It will be appreciated that in examples in which the first node comprises both the explainer and the critic, the first node may generate the one or more queries. Alternatively, the first node may receive the one or more queries from a second node, for example the critic 108. For example, the first node may comprise a network edge node or a cloud server.

The one or more requirements may comprise requirements that the ML model intends to fulfil by means of the output in the environment. For example, for a RL model, the policy of the RL model may comprise the requirements. The requirements of the ML model may therefore comprise for example goals or constraints of the ML model.

It will be appreciated that there may need to be a specification language that is common to both the explainer and the critic. This specification language may be used by the critic to question the reachability of a goal or why a particular Key Performance Indicator (KPI) was not met by the output of the ML model. This specification language may encompass contrastive (if not this path then) and abductive (this is most likely due to) answers to queries.

For example, the requirements may be constructed using the Easy Approach to Requirements Syntax (EARS). EARS has been shown to drastically reduce or even eliminate the main problems typically associated with natural language (NL) requirements.

There are a number of different types of requirements, for example:
1. Ubiquitous requirements: This type of requirement may be considered always active within the ML model. In other words, they are not invoked by an event or input, nor are they limited to a subset of the system's operating states.

For example, the following template may generate a ubiquitous requirement—The <system name> shall <system response>.
2. State-driven requirements. State-driven requirements are active throughout the time that a defined state in the environment remains true.

For example, the following template may generate an example state-driven requirement: WHILE <in a specific state> the <system name> shall <system response>.
3. Event-driven requirements: Event-driven requirements require a response only when an event is detected at in the environment.

For example, the following template may generate an example event-driven requirement—WHEN <trigger> the <system name> shall <system response>
4. Optional feature requirements: Optional feature requirements apply only when an optional feature is present as a part of the system.

For example, the following template may generate an optional feature requirement WHERE <feature is included> the <system name> shall <system response>
5. Unwanted behaviour requirements: ‘Unwanted behaviour requirements’ is a general term used to cover all situations that are undesirable.

For example, the following template may generate an unwanted behaviour requirement: IF <trigger>, THEN the <system name> shall <system response>.

The queries may also be of a templated form. For example, each query may be generated based on a query template. For example, a set of query templates may be associated with each type of output. For example, for an output that comprises a plan step to cause a drone to travel in a particular direction, there may be a predetermined set of query templates that can be used to generate appropriate queries for that particular step.

The query templates may comprise templates of a contrastive form. For example, the query templates may be of the form “Why A rather than B?”, where A is the fact (what occurred in the plan) and B is the foil (e.g. the hypothetical alternative expected by the stakeholder).

The following are further examples of query templates:
“Why is action A used in the plan, rather than not being used?” This constraint would enquire why the action A is being used in the plan.
“Why is action A not used in the plan, rather than being used?” This constraint may recommend that the action A is applied at some point in the plan.
“Why is action A used, rather than action B?” This constraint is a combination of the previous two, which recommends that the plan include action B and not action A.
“Why is action A used before/after action B (rather than after/before)?” This constraint recommends that if action A is used, action B must appear earlier/later in the plan.
“Why is action A used outside of time window W, rather than only being allowed inside W?” This constraint recommends the planner schedules action A within a specific time window.

The method of FIG. 2 then further comprises, for each of the one or more queries performing a reinforcement learning (RL) process.

The RL process comprises steps 202 to 204.

In step 202, the RL process comprises generating a first set of answers to the query based on the one or more requirements. For example, the explainer may provide multiple answers to the query using the aforementioned EARS templates.

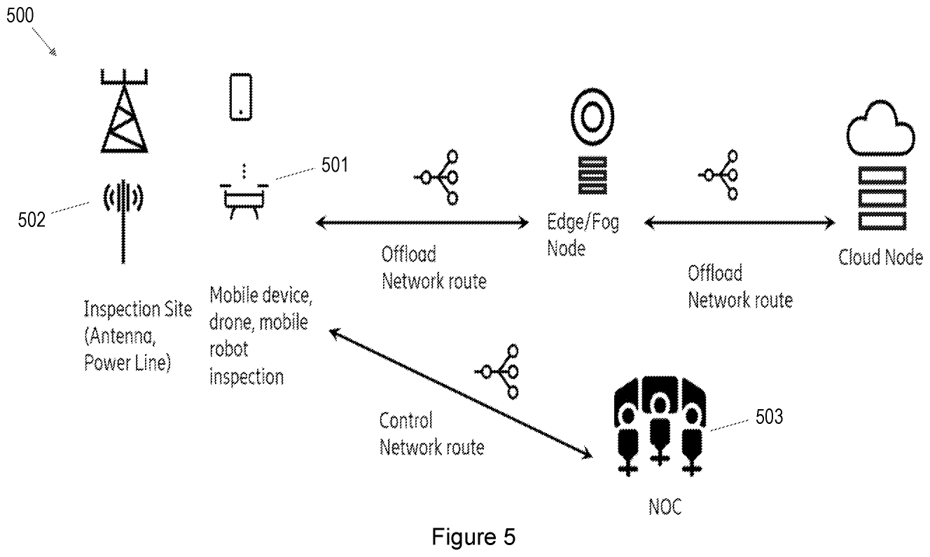

In other words, the requirements, which may be given in EARS templated format as described above (or any other suitable templated format) may be used as initial answers to a query. In other words, as the requirements capture constrained and known behaviour of the ML model, these requirements, and the behaviour they capture, may be used to provide an explanation (or answer) to a query. An example of how these requirements may provide answers is described in more detail with reference to FIG. 5.

In step 203, the RL process comprises obtaining a first set of rewards associated with the query, wherein each reward in the first set of rewards is associated with a respective answer in the first set of answers. Each reward is determined based on one or more metrics. In some examples, the first set of rewards is generated by the critic and transmitted to the explainer. In other examples, where the first node comprises the critic and the explainer, the first node may generate the first set of rewards.

In step 204, the RL process comprises iteratively generating updated sets of answers associated with the query based on a set of rewards associated with a set of answers from a preceding iteration until a terminal set of answers is reached. For example, a second set of answers is generated based on the first set of rewards.

Step 204 may, for example, comprise generating an updated set of answers to the query based on a set of rewards from a preceding iteration and the one or more requirements; and obtaining an updated set of rewards associated with the query. Each reward in the updated set of rewards is then associated with a respective answer from the updated set of answers. For example, the explainer may be considered to be using the RL process to determine the most likely answer that would satisfy the query.

The iteration of step 204 may continue for as long as it is determined that one or more updated answers can be provided that could be associated with a reward that is greater than any of the rewards generated in any previous iteration. For example, there may be limits set over which the explainer is reasonably sure that no further improvements can be made. For example, there may be a limit on the time or computation required to provide further composite answers. In some examples, there may be a limit on the number of requirements in a composite answer. For example, there may be a limit of 3 requirements forming a composite answer.

In some examples, there may be a limit on a minimum reward change that is achieved per updated set of answers. In other words, if the minimum reward change is not achieved by an updated set of answers, the process is considered to have converged to the best possible reward, and the last updated set of answers is set as the terminal set of answers.

Responsive to a determination that one or more answers cannot be provided that could be associated with a reward that is greater than any of the rewards generated in any previous iteration, a last generated updated set of answers may be set as the terminal set of answers.

Alternatively, responsive to at least one reward from the RL process associated with each query meeting a first predetermined criterion (e.g. the reward indicating that the associated answer would pass the auditing), a last generated set of answers may be set as the terminal set of answers.

In other words, the RL process may comprise the explainer utilising RL to select from possible answers for a given query and may the RL process may continue until the terminal set of answers is reached. For example, the model-based Markov Decision Process (MDP) may be used generate the first set of answers, and/or any subsequent sets of answers. The MDP is a tuple of (S, A, P, R) where:
S is the set of possible states
A is the set of actions
P (s, a, s′) is the probability that action a in state s will lead to state s′
R (s, a, s′) is the reward for action a transitioning from state s to s′

The explainer may, for example, have the following states while providing answers to the one or more queries:

### States:

#0 Query_unanswered—In other words the process has just started and the query first set of answers to a query have not yet been provided
#1 Query_Explained_accepted—The query has been answered, and at least one of the answers meets a reward criteria.
#2 Query_Explained_rejected—The query has been answered, but none of the answers meet the reward criteria

The explainer may, for example, perform the following actions:

### Actions:

#0 Explain_Ubiquitous_Requirements—Use the Ubiquitous requirements of the ML model to answer the query
#1 Explain_State_Driven_Requirements—Use the State Driven requirements of the ML model to answer the query
#2 Explain_Event_Driven_Requirements—Use the Event Driven requirements of the ML model to answer the query
#3 Explain_Optional_Feature_Requirements—Use the Optional Feature requirements of the ML model to answer the query
#4 Explain_Unwanted_Behavior_Requirements Use the Unwanted Behaviour requirements of the ML model to answer the query
#5 Explain_Composition_Requirements—Use a composite of one or more requirements of the ML model to answer the query.

The explainer may, for example, receive the following rewards from the critic:

### Rewards:

#0 Explanation_Accepted (positive)
#1 Explanation_Partially_Accepted (positive)
#2 Explanation_Rejected (negative)

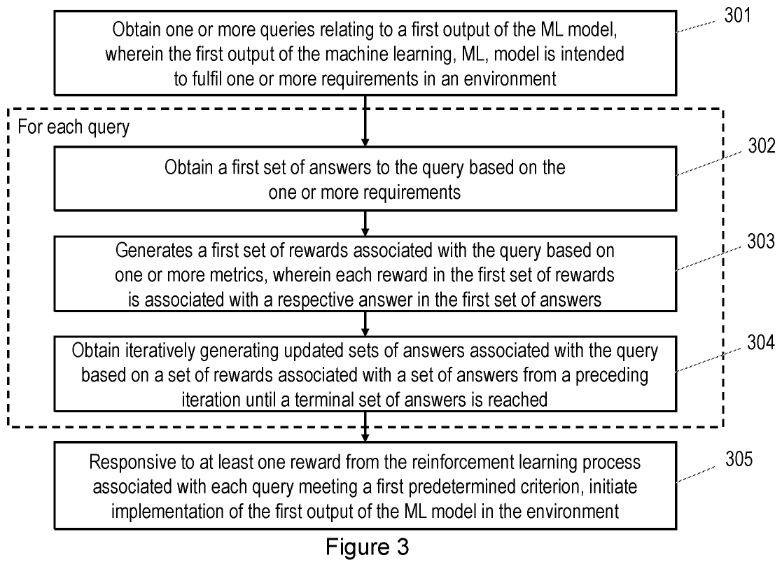

The rewards are evaluated by the critic agent using an evaluation model that mimics real-world performance (such as human expert evaluations, past statistics). How the rewards may be generated by the critic is described with more detail with reference to FIG. 3.

Once the RL process has been completed for each of the one or more queries, the method may, in some examples, pass to step 205.

In step 205 the method comprises, responsive to at least one reward from the RL process associated with each query meeting a first predetermined criterion, initiating implementation of the first output of the ML model in the environment. In other words, if each query is satisfied with at least one answer that meets the first predetermined criterion (e.g. a high enough reward value), then the first output of the ML model may be deemed successfully audited, and it may therefore be implemented in the environment.

For example, where the explainer and the critic are in separate nodes, step 205 may comprise the explainer transmitting the highest rewarded answers to the critic.

In examples in which the explainer and the critic are co-located, step 205 may comprise the first node alerting the knowledge base that the audit has been completed.

FIG. 3 illustrates a method in a second node, for obtaining one or more answers relating to a machine learning model. The method of FIG. 3 may, for example, be performed by the critic 108 as illustrated in FIG. 1. For example, the second node may comprise a network edge node or a cloud server.

In step 301, the second node obtains one or more queries relating to a first output of the ML model, wherein the first output of the machine learning, ML, model is intended to fulfil one or more requirements in an environment. The one or more queries may be generated by the critic node, for example, as described above with reference to FIG. 2. For example, the queries may be generated based on historical data relating to outputs generated by the ML model, and/or be based on the result of previous audits performed by the second node. It will also be appreciated that the queries posed by the critic may conform to a specific query template as described above. In some examples, the one or more queries may be received from a user input.

The method of FIG. 3 then further comprises, for each of the one or more queries performing a reinforcement learning (RL) process.

The RL process comprises steps 302 to 304.

In step 302, the second node obtains a first set of answers to the query based on the one or more requirements. For example, the second node may receive the first set of answers from the first node.

In step 303, the second node generates a first set of rewards associated with the query based on one or more metrics, wherein each reward in the first set of rewards is associated with a respective answer in the first set of answers.

The one or more metrics comprise one or metrics determined based on one or more of: a comprehensibility of each answer, a succinctness of each answer, an actionability of each answer, a reusability of each answer, an accuracy of each answer and a completeness of each answer.

The one or more metrics may be hidden from the explainer.

Users may also add additional metrics/queries to the critic knowledge base in order to aid in further exploration.

The one or more metrics comprise one or metrics determined based on one or more of:
Comprehensibility of the answer. In other words, how much effort is needed for a human to interpret the answer? This may be evaluated based on a number of nested loops in the answer. For example, the higher the number of nested loops, lower the comprehensibility.
Succinctness of the answer. In other words, how concise is the answer? This may be measured in terms of the size of the answer, for example the number of characters or words in the answer.
Actionability of the answer. In other words, how actionable is the answer, or what can be done with answer? This may be measured by easily the plan goal/heuristic can be changed based on the answer.
Reusability of the answer. In other words, could the answer be interpreted/reused by another AI system? For example, higher order concepts in the ontology can be reused in other plans more easily
Accuracy of the answer. Specific accuracy to current plan may be traded off with reusability.
Completeness of the answer. In other words, does the answer explain the decision completely, or only partially? For example, an answer may be considered more complete if it exposes the current state, events and intermediate steps that lead to the particular action.

For example, too generic an answer may not be well rewarded by the critic. Similarly, answers that are too detailed are also not well rewarded. The quality of the answer that is judged by the critic may have an objective measure.

Each reward may comprise a single value calculated based on one or more metrics. Alternatively, a reward may comprise a tuple with a different value for each different metric.

In step 304 the second node obtains iteratively generated updated sets of answers associated with the query based on a set of rewards associated with a set of answers from a preceding iteration until a terminal set of answers is reached, in which a second set of answers is generated based on the first set of rewards. For example, these iteratively generated updated sets of answers may be received from the explainer node. For each set of answers received, the second node may perform step 303 and generate a set of rewards for the set of answers.

Through this iterative process using the RL approach, the model can converge on the optimal level of answer for a particular query.

Once the RL process has been completed for each of the one or more queries, the method may, in some examples, pass to step 305.

In step 305 the method comprises, responsive to at least one reward from the RL process associated with each query meeting a first predetermined criterion, initiating implementation of the first output of the ML model in the environment. In other words, if each query is satisfied with at least one answer that meets the first predetermined criterion (e.g. a high enough reward value), then the first output of the ML model may be deemed successfully audited, and it may therefore be implemented in the environment.

For example, step 305 may comprise the second node alerting the knowledge base that the audit has been completed.

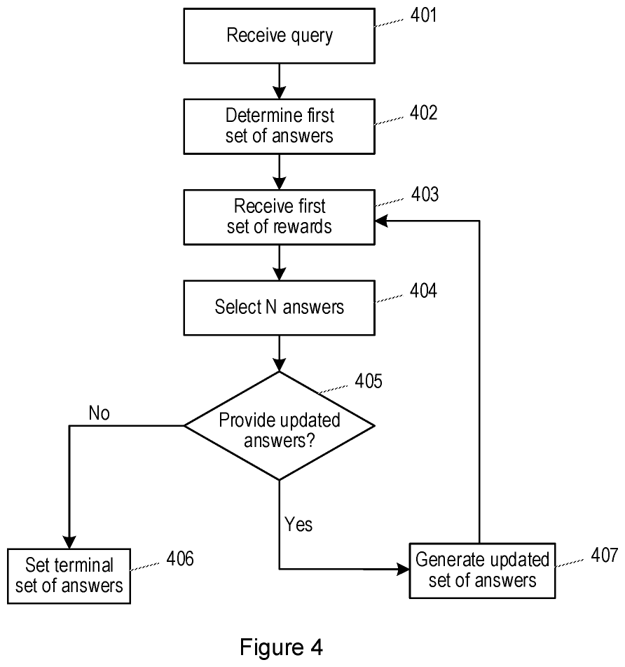

FIG. 4 illustrates an example of the iterative process of step 204 of FIG. 2 for a query in more detail. In this example, the explainer and critic are separate nodes. In this iterative process, the composite answers of the individual requirements of the ML model are composed to add further clarity to the answers. The process may take multiple rounds and may continue until no further improvements in rewards are seen. This may be an offline process, but an advantage is that the auditing may help improve the quality of answers when implemented online.

In step 401, the explainer receives the query from the critic. In step 402, the explainer determines the first set of answers. In this example, each answer in the first set of answers is one of the one or more requirements of the ML model.

In step 403, the explainer receives the first set of rewards from the critic. In step 404, the explainer selects N (where N is an integer) of the answers associated with the highest rewards received in step 403.

In step 405, the explainer determines whether one or more updated answers can be provided that could be associated with a reward that is greater than any of the rewards generated in any previous iteration. The one or more updated answers may each comprise composite answers formed from at least two of the one or more requirements. For example, the composite requirements may be formed from the N answers selected in step 404.

If in step 405 it is determined that no more answers can be provided that could be associated with a reward that is greater than any of the rewards generated in any previous iteration, a last generated updated set of answers may be set as the terminal set of answers in step 406.

If in step 405 it is determined that one or more answers can be provided that could be associated with a reward that is greater than any of the rewards generated in any previous iteration, then an updated set of answers is generated in step 407. As previously described, the updated set of answers may comprise composite answers formed from at least two of the one or more requirements. It will be appreciated that the composite answers may effectively provide a description of further intermediary steps in the answer to the query.

The method then returns to step 403 in which a set of rewards is received for the updated set of answers. The method may then further continue until step 406 is reached.

The terminal set of answers may then be used in an online phase once the audit has been passed.

For example, corresponding queries and answers having the highest rewards (e.g. X number of answers with the highest X rewards) are obtained. The template for each of these answers may be taken and stored as a terminal answer template. In other words, the answers may be used as a template in which the objects in the answers can be replaced to correspond with different systems.

In some examples, for each of the one or more queries, a respective terminal answer template is stored based on the structure of each of the terminal set of answers to the query.

In some examples, for each of the one or more queries, the terminal answer template for the terminal set of answers is stored associated with a query template for the associated query and/or an indication of a type of a part of the first output that the query referred to. For example, if the ML model comprised an AI planner, and the query related to a step in the plan output, the following tuple may be stored:
<plan step template><query template><terminal answer template>.

In some examples therefore, responsive to receiving one or more queries relating to a second output of the ML model, one or more answers to one or more additional queries relating to the second output of the ML model may be generated, wherein the one or more answers are generated based on the terminal answer template.

In other words, in the online mode (e.g. for subsequent outputs of the ML model), a query and what the query relates to may be matched to stored templates. For example, a stored tuple may be:
Plan step template: REACH <LOCATION> WITH <VEHICLE>
Query template: Why is action REACH <LOCATION> in the plan, rather than being omitted?
Terminal Answer Template: WHILE <location is uninspected> WHERE <vehicle present> the <inspection system> shall <perform inspection>.

Therefore, if a query of “Why is action reach <base station site 1> in the plan rather than being omitted?” is received relating to a plan step of “reach <base station site 1> with <drone 1>”, then this query and plan step may be matched to the above tuple. The explainer may then output an answer to the query using the associated terminal answer template, for example “while <base station site 1 is uninspected> WHERE <drone 1> is present the <base station inspection system> shall <perform inspection of base station>”.

This answer would then have a lower chance of being rejected by a stakeholder as it has already been audited for another output of the ML model. In the online mode, the explainer may be deployed on a device(s) (for example a drone) within the environment. In some examples, the explainer may be deployed on a Network Operating Centre (NOC) or an edge server that is able to monitor device outputs in the environment.

FIG. 5 illustrates an example in which the ML model is configured to determine at least one plan for a drone to inspect one or more defects in a telecommunication system 500.

In the system of FIG. 5, a mobile drone 501 is used to inspect sites, e.g. telecommunication tower (or electrical tower) 502, in a telecommunication system 500.

The mobile drone may be configured to collect coarse grained images and may process the images to determine any potential failure locations.

The images may be uploaded to an Edge or a Cloud server where appropriate ML inference models are located.

The offloading of data may be performed over an appropriate network slice provisioned over the network.

In case a failure location is confirmed, the drone is informed and collects fine grained images. These images may then be sent back to a Network Operating Centre (NOC) 503 for failure escalation and resolution.

The ML model may be run by the NOC 503. The ML model may be an AI planner configured to provide multiple plans to resolve defects in the telecommunication system 500 via the drone 501 acting as an inspection agent.

An expert rule-book knowledge base may incorporate all possible KPIs and goals that are to be followed.

The critic may then query validity of defect, the plan to rectify and/or the costs involved in rectifying the defect. The explainer may then provide answers to the critic. Once a reward threshold is reached, the planner and explainer are considered to pass the audit and are allowed to be deployed to live environments.

The following is an example of an AI plan that may be typically generated for site inspection in the FIG. 5:
0.001: (REACH LOCATION1 DRONE1)[1.000]; cost 1.000
1.002: (CAPTURE-IMAGE LOCATION1 DRONE1 IMAGE1)[1.000]; cost 1.000
2.003: (GENERATE-NETWORK-SLICE DRONE1 CHANNEL1 EDGE-NODE1 IMAGE1)[1.000]; cost 1.000
3.003: (OFFLOAD-IMAGE-EDGE DRONE1 CHANNEL1 EDGE-NODE1 IMAGE1)[1.000]; cost 1.000
4.004: (PROCESS-IMAGE IMAGE1 ML-MODEL1 ACCURACY1)[1.000]; cost 1.000
5.005: (RESPOND-AGENT LOCATION1 FAILURE)[1.000]; cost 1.000
6.008: (RAISE-FAILURE-ALARM LOCATION1 TICKET1)[1.000]; cost 1.000

The following are examples of requirements of the ML model:
The <inspection system> shall <reach location>
WHILE <location1 is uninspected> the <inspection system> shall <fly drone to inspect>
WHEN <location uninspected> the <inspection system> shall <reach with drone inspector>
WHERE <drone inspector present> the <inspection system> shall <perform inspection>
IF <drone inspector idle>, THEN the <inspection system> shall <fly drone inspector>
WHILE <computation is pending> the <inspection system> shall <allocate computation>
WHEN <image unprocessed> the <inspection system> shall <perform computation>
WHERE <image unprocessed> the <inspection system> shall <perform processing>
IF <drone inspector near Edge>, THEN the <inspection system> shall <offload computation>
WHILE <drone system is unconnected> the <inspection system> shall <establish connection>
WHEN <drone system is unconnected> the <inspection system> shall <set up a slice>
WHERE <drone inspector is inspecting> the <inspection system> shall <set up slice>
IF <drone inspector unconnected>, THEN the <inspection system> shall <provide connectivity>
WHILE <inspecting> the <inspection system> shall <raise failure alarms>
WHEN <failure detected> the <inspection system> shall <raise alarm>
WHERE <drone inspector is inspecting> the <inspection system> shall <look for alarms>

Answers provided by the explainer may then be evaluated using the previously described metrics by the critic. Table 1 below illustrates answers for a number of different queries posed by the critic and their associated rewards. The non-underlined answers are examples of answers that comprise only one of the requirements above. The underlined answers are examples of composite answers that are formed form two or more of the above requirements, and may be provided in a later iteration of the process.

| | | Critic Rewards | |
|---|---|---|---|
| | Explainer (EARS Specification Templates | (matching expected | Critic criteria for |
| Critic Agent Queries (Query Templates) | and Compositions) | template answers) | explainability audits |
| Why is action <REACH LOCATION1> | The <inspection system> shall <reach location> | +10 | High Succinctness, |
| in the plan, rather than being omitted? | | | Low Accuracy, |
| | | | Low Completeness |
| 0.001: (REACH LOCATION1 | WHILE <location1 is uninspected> the <inspection | +20 | High Accuracy, |
| DRONE1)[1.000] | system> shall <fly drone to inspect> | | High Completeness |
| | WHEN <location uninspected> the <inspection | +20 | High Accuracy, |
| | system> shall <reach with drone inspector> | | High Completeness |
| | WHERE <drone inspector present> the <inspection | +5 | Low Comprehensibility, |
| | system> shall <perform inspection> | | Low Accuracy |
| | IF <drone inspector idle>, THEN the <inspection | 0 | Low Comprehensibility, |
| | system> shall <fly drone inspector> | | Low Accuracy |
| | WHILE <location1 is uninspected> WHERE <drone | +25 | High Accuracy, |
| | inspector present> the <inspection system> shall | | High Completeness, |
| | <perform inspection> | | High Reusability |
| Why is action <OFFLOAD-IMAGE_{—} | The <inspection system> shall <complete inspection> | +5 | High Succinctness |
| EDGE> used instead of <DRONE1 | | | |
| COMPUTE>? | | | |
| 3.003: (OFFLOAD-IMAGE-EDGE | WHILE <computation is pending> the <inspection | +10 | High Reusability, |
| DRONE1 CHANNEL1 EDGE- | system> shall <allocate computation> | | Low Completeness |
| NODE1 IMAGE1)[1.000];; | | | |
| cost 1.000 | | | |
| | WHEN <image unprocessed> the <inspection system> | +10 | High Reusability, |
| | shall <perform computation> | | Low Completeness |
| | WHERE <image unprocessed> the <inspection system> | 0 | Low Accuracy |
| | shall <perform processing> | | |
| | IF <drone inspector near Edge>, THEN the <inspection | +20 | High Accuracy, |
| | system> shall <offload computation> | | High Reusability |
| | WHEN <image unprocessed> WHILE <computation | +30 | High Completeness, |
| | is pending> IF <drone inspector near Edge>. THEN | | High Reusability, |
| | the <inspection system> shall <offload computation> | | High Accuracy |
| Why is action <GENERATE-NETWORK- | The <inspection system> shall <perform inspection> | 0 | Low Comprehensibility |
| SLICE> done before <OFFLOAD>? | | | |
| 2.003: (GENERATE-NETWORK-SLICE | WHILE <drone system is unconnected> the <inspection | +10 | High Reusability, |
| DRONE1 CHANNEL1 EDGE-NODE1 | system> shall <establish connection> | | Low Accuracy |
| IMAGE1)[1.000];; cost 1.000 | | | |
| | WHEN <drone system is unconnected> the <inspection | +20 | High Reusability, |
| | system> shall <set up a slice> | | High Accuracy |
| | WHERE <drone inspector is inspecting> the | +20 | High Reusability, |
| | <inspection system> shall <set up slice> | | High Accuracy |
| | IF <drone inspector unconnected>, THEN the | +10 | Low Accuracy |
| | <inspection system> shall <provide connectivity> | | |
| | WHEN <drone system is unconnected> WHILE | +25 | High Completeness, |
| | <drone system is unconnected> the <inspection | | High Accuracy, |
| | system> shall <set up a slice> | | High Reusability |
| Why is the action <RAISE FAULT> | The <inspection system> shall <perform inspection> | 0 | Low Completeness |
| done within the time window <5-10>? | | | |
| 6.008: (RAISE- FAILURE-ALARM | WHILE <inspecting> the <inspection system> shall | 0 | Low Completeness |
| LOCATION1 TICKET1)[1.000];; | <raise failure alarms> | | |
| cost 1.000 | | | |
| | WHEN <failure detected> the <inspection system> | +10 | High Reusability |
| | shall <raise alarm> | | |
| | WHERE <drone inspector is inspecting> the | 0 | Low Completeness |
| | <inspection system> shall <look for alarms> | | |
| | IF <drone inspector unconnected>, THEN the | +20 | High Reusability, |
| | <inspection system> shall <provide connectivity> | | High Comprehensibility |
| | WHEN <failure detected> IF <drone inspector | +25 | High Reusability, |
| | unconnected>, THEN the <inspection system> | | High Comprehensibility, |
| | shall <provide connectivity> | | High Accuracy |

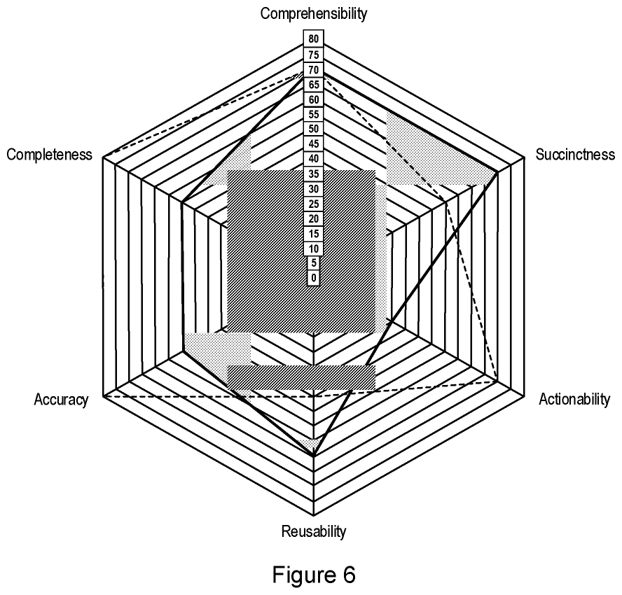

FIG. 6 is a radar diagram that illustrates an example technique to objectively measure the efficacy of the answers. The greater the area covered in the radar diagram, the better the “quality” of the answer. Thus, the composite (shown with a dotted line) answers are preferred over the answers comprising only one requirement of the ML model (shown with a solid line). These metrics may then be converted to an RL reward that is passed onto the explainer.

This iterative process of queries and answers between the explainer and the critic improves the quality of answers and reduces the possibility of explanation failure. Only the set of plans that are able to pass the auditing requirements may be processed for deployment in the environment.

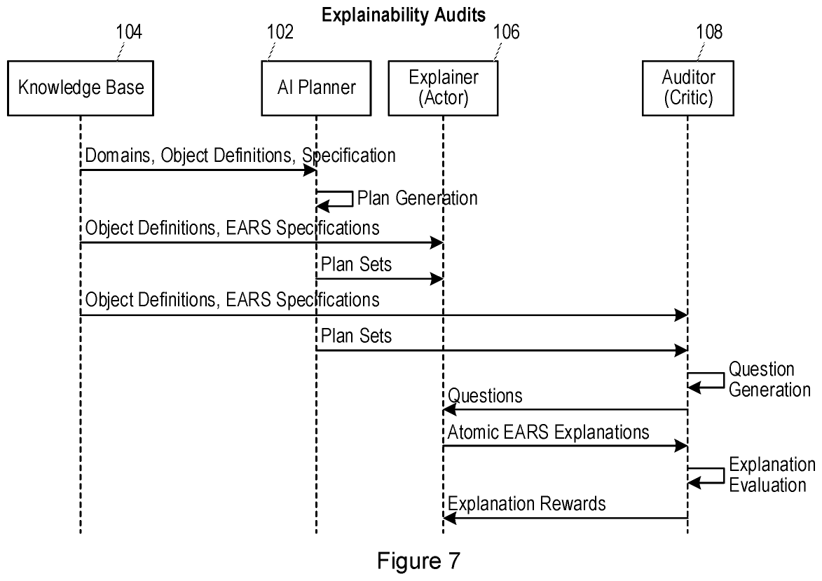

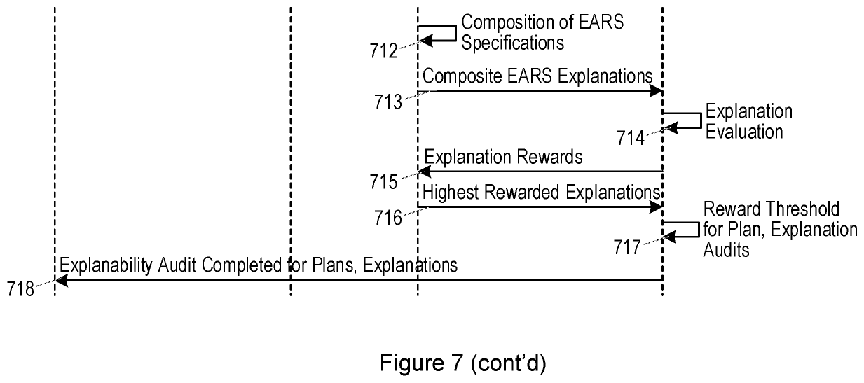

FIG. 7 is a signalling diagram illustrating an example implementation of the methods of FIGS. 2 and 3 explained with reference to FIG. 1. In this example the first node comprises the explainer node 106, and the second node comprises the critic node 108. As previously described, it will be appreciated that in some embodiments the functionality of the explainer and the critic may be co-located within the same node.

In this example the ML model comprises an AI planner 102.

In step 701, a knowledge base 104 provides relevant knowledge to the AI planner 102 for preparation of plans. For example, the domains, object definitions and requirements of the environment which may be needed to define an AI planning problem. In step 702, the AI planner 102 generates one or more output plans.

In steps 703 and 704, the knowledge base 104 provides the object definitions and templated versions of the requirements to the explainer 106 and the critic 108 respectively. For example, the requirements may be templated using EARS.

In steps 705 and 706, the AI planner 102 outputs the one or more output plans to the explainer 106 and to the critic 108 respectively.

In step 707, the critic 108 generates one or more queries relating to each of the one or more output plans.

In step 708, the critic 108 transmits the queries to the explainer 106.

In step 709, the explainer 106 provides a first set of answers to each query to the critic 108. Each answer in the first sets of answers may comprise only one of the EARS requirements.

In step 710, the critic 108 evaluates the first sets of answers based on one or more metrics as described above.

In step 711, the critic 108 provides rewards to the explainer 106, wherein each reward is associated with a respective answer from the first sets of answers received in step 709.

In step 712, the explainer 106 generates a second set of answers to each query. Each answer in the second sets of answers may comprise a composite answer formed from at least two of the requirements.

In step 713, the explainer 106 transmits the second sets of answers to the critic 108.

In step 714, the critic 108 evaluates the second sets of answers based on the one or more metrics.

In step 715, the critic 108 provides rewards to the explainer 106, wherein each reward is associated with a respective answer from the second sets of answers.

In step 716 the explainer 106 determines that the last generated set of answers comprises the terminal set of answers and transmits the highest rewarded answers for each query to the critic 108. In step 717, the critic 108 then checks that at least one of the highest rewarded answers for each query meets a threshold for the plan.

Responsive to at least one of the highest rewarded answers for each query meeting the threshold, in step 718 the critic 108 indicates to the knowledge base 104 that the audit for the AI planner 102 has been passed.

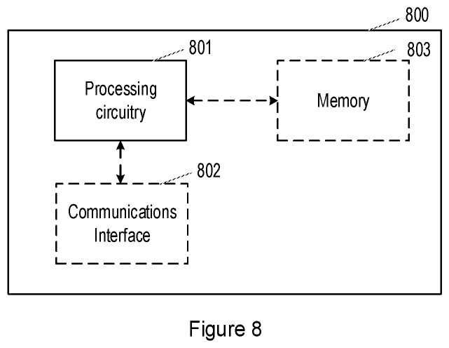

FIG. 8 illustrates a first node 800 comprising processing circuitry (or logic) 801. The first node may comprise an explainer, such as the explainer 106 illustrated in FIG. 1. The processing circuitry 801 controls the operation of the first node 800 and can implement the method described herein in relation to an first node or an explainer. The processing circuitry 801 can comprise one or more processors, processing units, multi-core processors or modules that are configured or programmed to control the first node 800 in the manner described herein. In particular implementations, the processing circuitry 801 can comprise a plurality of software and/or hardware modules that are each configured to perform, or are for performing, individual or multiple steps of the method described herein in relation to the first node 800.

Briefly, the processing circuitry 801 of the first node 800 is configured to: obtain one or more queries relating to a first output of the ML model, wherein the first output of the machine learning, ML, model is intended to fulfil one or more requirements in an environment; for each of the one or more queries perform a reinforcement learning process. The reinforcement learning process comprises generating a first set of answers to the query based on the one or more requirements; obtaining a first set of rewards associated with the query, wherein each reward in the first set of rewards is associated with a respective answer in the first set of answers, wherein the each reward is determined based on one or more metrics; and iteratively generating updated sets of answers associated with the query based on a set of rewards associated with a set of answers from a preceding iteration until a terminal set of answers is reached, in which a second set of answers is generated based on the first set of rewards. The processing circuitry 801 of the first node 800 may then be further configured to, responsive to at least one reward from the reinforcement learning process associated with each query meeting a first predetermined criterion, initiate implementation of the first output of the ML model in the environment.

In some embodiments, the first node 800 may optionally comprise a communications interface 802. The communications interface 802 of the first node 800 can be for use in communicating with other nodes, such as other virtual nodes. For example, the communications interface 802 of the first node 800 can be configured to transmit to and/or receive from other nodes requests, resources, information, data, signals, or similar. The processing circuitry 801 of first node 800 may be configured to control the communications interface 802 of the first node 800 to transmit to and/or receive from other nodes requests, resources, information, data, signals, or similar.

Optionally, the first node 800 may comprise a memory 803. In some embodiments, the memory 803 of the first node 800 can be configured to store program code that can be executed by the processing circuitry 801 of the first node 800 to perform the method described herein in relation to the first node 800. Alternatively or in addition, the memory 803 of the first node 800, can be configured to store any requests, resources, information, data, signals, or similar that are described herein. The processing circuitry 801 of the first node 800 may be configured to control the memory 803 of the first node 800 to store any requests, resources, information, data, signals, or similar that are described herein.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

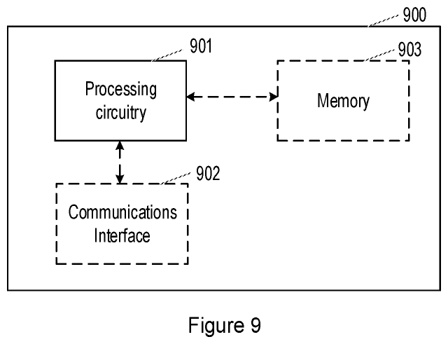

FIG. 9 illustrates a second node 900 comprising processing circuitry (or logic) 901. The second node may comprise a critic, such as the critic 108 illustrated in FIG. 1. The processing circuitry 901 controls the operation of the second node 900 and can implement the method described herein in relation to a second node or a critic. The processing circuitry 901 can comprise one or more processors, processing units, multi-core processors or modules that are configured or programmed to control the second node 900 in the manner described herein. In particular implementations, the processing circuitry 901 can comprise a plurality of software and/or hardware modules that are each configured to perform, or are for performing, individual or multiple steps of the method described herein in relation to the second node 900.

Briefly, the processing circuitry 901 of the second node 900 is configured to: obtain one or more queries relating to a first output of the ML model, wherein the first output of the machine learning, ML, model is intended to fulfil one or more requirements in an environment; for each of the one or more queries perform a reinforcement learning process. The reinforcement learning process comprises obtaining a first set of answers to the query based on the one or more requirements; generating a first set of rewards associated with the query based on one or more metrics, wherein each reward in the first set of rewards is associated with a respective answer in the first set of answers; obtaining iteratively generated updated sets of answers associated with the query based on a set of rewards associated with a set of answers from a preceding iteration until a terminal set of answers is reached, in which a second set of answers is generated based on the first set of rewards. The processing circuitry 901 of the second node 900 may then be further configured to responsive to at least one reward from the reinforcement learning process associated with each query meeting a first predetermined criterion, initiating implementation of the first output of the ML model in the environment.

In some embodiments, the second node 900 may optionally comprise a communications interface 902. The communications interface 902 of the second node 900 can be for use in communicating with other nodes, such as other virtual nodes. For example, the communications interface 902 of the second node 900 can be configured to transmit to and/or receive from other nodes requests, resources, information, data, signals, or similar. The processing circuitry 901 of second node 900 may be configured to control the communications interface 902 of the second node 900 to transmit to and/or receive from other nodes requests, resources, information, data, signals, or similar.

Optionally, the second node 900 may comprise a memory 903. In some embodiments, the memory 903 of the second node 900 can be configured to store program code that can be executed by the processing circuitry 901 of the second node 900 to perform the method described herein in relation to the second node 900. Alternatively or in addition, the memory 903 of the second node 900, can be configured to store any requests, resources, information, data, signals, or similar that are described herein. The processing circuitry 901 of the second node 900 may be configured to control the memory 903 of the second node 900 to store any requests, resources, information, data, signals, or similar that are described herein.

Embodiments described herein therefore provide methods and apparatuses for implementing an auditing system to check for explainability of ML models using reinforcement learning. Accurate answers to queries relating to outputs of a ML model may be provided in a templated format, for example using EARS syntax rules.

Critic rewarded answers may be composed in an optimal fashion to ensure explanations are neither too generic nor too verbose The resulting combinations of outputs, queries and answers have improved on-field performance due to offline explanation audits.

Because of the structured domains, the space of outputs, queries and answers are expected to be well-defined.

Once converged, the RL system described in the embodiments above may be deployed for any ML system (for example any AI planning system) and may output good answers for any query in a live manner.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method in a first node for generating one or more answers relating to a machine learning, ML, model, the method comprising:
obtaining one or more queries relating to a first output of the ML model, wherein the first output of the machine learning, ML, model is intended to fulfil one or more requirements in an environment;
for each of the one or more queries performing a reinforcement learning process comprising:
generating a first set of answers to the query based on the one or more requirements;
obtaining a first set of rewards associated with the query, wherein each reward in the first set of rewards is associated with a respective answer in the first set of answers, wherein each reward in the first set of rewards is determined based on one or more metrics; and
iteratively generating updated sets of answers associated with the query based on a set of rewards associated with a set of answers from a preceding iteration until a terminal set of answers is reached, in which a second set of answers is generated based on the first set of rewards; and
responsive to at least one reward from the reinforcement learning process associated with each query meeting a first predetermined criterion, initiating implementation of the first output of the ML model in the environment.

2. The method of claim 1, wherein the step of iteratively generating updated sets of answers comprises:
generating an updated set of answers to the query based on a set of rewards from a preceding iteration and the one or more requirements; and
obtaining an updated set of rewards associated with the query, wherein each reward in the updated set of rewards is associated with a respective answer from the updated set of answers.

3. The method as claimed in claim 2, further comprising performing the step of generating an updated set of answers responsive to a determination that one or more updated answers can be provided that could be associated with a reward that is greater than any of the rewards generated in any previous iteration.

4. The method as claimed in claim 2, further comprising:
responsive to a determination that one or more answers cannot be provided that could be associated with a reward that is greater than any of the rewards generated in any previous iteration, setting a last generated updated set of answers as the terminal set of answers, or
responsive to at least one reward from the reinforcement learning process associated with each query meeting a first predetermined criterion, setting a last generated set of answers as the terminal set of answers.

5. (canceled)

6. The method as claimed in claim 1, wherein the step of generating a first set of answers to the query based on the one or more requirements comprises generating a first set of answers using a Markov Decision Process.

7. The method as claimed in claim 1, wherein
each answer within the first set of answers is based on a respective templated format, and
each respective templated format comprises a Easy Approach to Requirements Syntax template.

8. (canceled)

9. The method as claimed in claim 1, wherein
each answer within the first set of answers comprise at least one of the one or more requirements,
at least one answer within each iteration of the updated set of answers comprises a composite answer formed of at least two of the one or more requirements, and
the step of iteratively generating updated sets of answers associated with the query until a terminal set of answers is reached comprises iteratively generating updated sets of composite answers associated with the query.

10. (canceled)

11. (canceled)

12. The method as claimed in claim 1, wherein the method further comprises:
for each of the one or more queries, storing a terminal answer template based on the structure of the terminal set of answers to the query.

13. The method as claimed in claim 12, further comprising: for each of the one or more queries, storing the terminal answer template associated with a query template for the query and/or an indication of a type of a part of the first output that the query referred to.

14. The method as claimed in claim 12, the method further comprising:
responsive to receiving one or more queries relating to a second output of the ML model, generating one or more answers to one or more additional queries relating to the second output of the ML model, wherein the one or more answers are generated based on the terminal answer template.

15. The method as claimed in claim 1, wherein the one or more queries are generated based on one or more respective query templates associated with a type of the first output of the ML model.

16. The method as claimed in claim 1, wherein the one or more metrics comprise one or metrics determined based on one or more of: a comprehensibility of each answer, a succinctness of each answer, an actionability of each answer, a reusability of each answer, an accuracy of each answer and a completeness of each answer.

17. The method as claimed in claim 1, wherein the ML model is configured to determine at least one plan for a drone to inspect one or more defects in a telecommunication system.

18. A method in a second node, for obtaining one or more answers relating to a machine learning model, the method comprising:
obtaining one or more queries relating to a first output of the ML model, wherein the first output of the machine learning, ML, model is intended to fulfil one or more requirements in an environment;
for each of the one or more queries performing a reinforcement learning process comprising:
obtaining a first set of answers to the query based on the one or more requirements;
generating a first set of rewards associated with the query based on one or more metrics, wherein each reward in the first set of rewards is associated with a respective answer in the first set of answers;
obtaining iteratively generated updated sets of answers associated with the query based on a set of rewards associated with a set of answers from a preceding iteration until a terminal set of answers is reached, in which a second set of answers is generated based on the first set of rewards; and
responsive to at least one reward from the reinforcement learning process associated with each query meeting a first predetermined criterion, initiating implementation of the first output of the ML model in the environment.

19. The method as claimed in claim 18 further comprising generating the one or more queries based on one or more respective query templates associated with a type of the first output of the ML model.

20. The method as claimed in claim 18, wherein
each answer within the first set of answers is based on a respective templated format, and
each respective templated format comprises a Easy Approach to Requirements Syntax template.

21. (canceled)

22. The method as claimed in claim 18, wherein the one or more metrics comprise one or metrics determined based on one or more of: a comprehensibility of each answer, a succinctness of each answer, an actionability of each answer, a reusability of each answer, an accuracy of each answer and a completeness of each answer.

23. The method as claimed in claim 18, wherein the ML model is configured to determine at least one plan for a drone to inspect one or more defects in a telecommunication system.

24. A first node for generating one or more answers relating to a machine learning, ML, model, the first node comprising processing circuitry configured to cause the first node to:
obtain one or more queries relating to a first output of the ML model, wherein the first output of the machine learning, ML, model is intended to fulfil one or more requirements in an environment;
for each of the one or more queries perform a reinforcement learning process comprising:
generating a first set of answers to the query based on the one or more requirements;
obtaining a first set of rewards associated with the query, wherein each reward in the first set of rewards is associated with a respective answer in the first set of answers, wherein each reward in the first set of rewards is determined based on one or more metrics; and
iteratively generating updated sets of answers associated with the query based on a set of rewards associated with a set of answers from a preceding iteration until a terminal set of answers is reached, in which a second set of answers is generated based on the first set of rewards; and
responsive to at least one reward from the reinforcement learning process associated with each query meeting a first predetermined criterion, initiate implementation of the first output of the ML model in the environment.

25. (canceled)

26. A second node for obtaining one or more answers relating to a machine learning model, the second node comprising processing circuitry configured to cause the second node to:
obtain one or more queries relating to a first output of the ML model, wherein the first output of the machine learning, ML, model is intended to fulfil one or more requirements in an environment;
for each of the one or more queries perform a reinforcement learning process comprising:
obtaining a first set of answers to the query based on the one or more requirements;
generating a first set of rewards associated with the query based on one or more metrics, wherein each reward in the first set of rewards is associated with a respective answer in the first set of answers;
obtaining iteratively generated updated sets of answers associated with the query based on a set of rewards associated with a set of answers from a preceding iteration until a terminal set of answers is reached, in which a second set of answers is generated based on the first set of rewards; and
responsive to at least one reward from the reinforcement learning process associated with each query meeting a first predetermined criterion, initiate implementation of the first output of the ML model in the environment.

27. (canceled)

28. (canceled)
